(19) United States
(12) Patent Application Publication
(10) Pub. No.: US 2025/0357515 A1
(43) Pub. Date: Nov. 20, 2025

(54) SOUND DAMPER, IN PARTICULAR FOR A FUEL-CELL SYSTEM

(71) Applicant: Purem GmbH, Neunkirchen (DE)

(72) Inventors: Peter Wink, Uhingen (DE); Jochen Hammer, Stuttgart (DE); Frank Berkemer, Eningen u. A. (DE); Thomas Übele, Sulzbach an der Murr (DE); Matthias Conrath, Karlsruhe (DE)

(21) Appl. No.: 19/209,505

(22) Filed: May 15, 2025

(30) Foreign Application Priority Data
May 15, 2024 (DE) 10 2024 113 518.2
Aug. 6, 2024 (DE) 10 2024 122 344.8

(51) Int. Cl. H01M 8/0662; F01N 1/08; F01N 1/10; H01M 8/04746

(52) U.S. Cl. CPC H01M 8/0662; F01N 1/082; F01N 1/10; H01M 8/04761; F01N 2240/32; H01M 2250/20

(57) ABSTRACT

A sound damper for a fuel-cell system includes a tubular sound-damper casing made of plastic material. The casing is elongate in the direction of a sound-damper longitudinal axis. A first sound-damper end piece made of plastic material is fixed to the sound-damper casing at a first axial end of the sound-damper casing. A second sound-damper end piece made of plastic material is fixed to the sound-damper casing at a second axial end of the sound-damper casing. On at least one sound-damper end piece, at least one fastening element is provided for fastening the sound damper to a support structure.

### CROSS-REFERENCE TO RELATED APPLICATIONS

This application claims priority of German patent application nos. 10 2024 113 518.2, filed May 15, 2024, and 10 2024 122 344.8, filed Aug. 6, 2024, the entire contents of which are incorporated herein by reference.

### TECHNICAL FIELD

The present disclosure relates to a sound damper that may be used, in particular, in an exhaust system of a fuel-cell system, for example in a vehicle, for damping noise produced in the fuel-cell system and propagating via the fuel-cell exhaust.

### BACKGROUND

The noise generated during operation of a fuel-cell system, for example by compressors or other units, is highly dependent on the structural configuration, in particular also on the dimensions selected for the fuel cell output to be provided, of a fuel cell, for example a PEM fuel cell, realized for example as a fuel-cell stack, or including one or a plurality of fuel-cell stacks. The efficient damping of noise produced during fuel cell operation and transmitted, or propagated, in the fuel cell exhaust requires a corresponding dimensioning of a sound damper provided in an exhaust system of such a fuel cell system. The size of the installation space available in a vehicle, for example, is also a factor influencing the dimensioning of such a sound damper.

### SUMMARY

It is an object of the present disclosure to provide a sound damper, in particular for a fuel cell system, that may be constructed in a simple manner such that it can be adapted to different purposes or application environments.

According to a first aspect of the present disclosure, this object is achieved by a sound damper, in particular for a fuel cell system, including:

a tubular sound-damper casing, made of plastic material, that is elongate in the direction of a sound-damper longitudinal axis, a first sound-damper end piece, made of plastic material, that is fixed to the sound-damper casing at a first axial end of the sound-damper casing, a second sound-damper end piece, made of plastic material, that is fixed to the sound-damper casing at a second axial end of the sound-damper casing, on at least one sound-damper end piece, at least one fastening element for fastening the sound damper to a support structure.

The sound damper constructed according to the disclosure, with its sound-damper casing made of plastic material and its two sound-damper end pieces also made of plastic material, has a modular structure. Since the sound-damping characteristic of such a sound damper is determined substantially by the volume enclosed by the sound-damper casing, the length of the sound-damper casing extending between the two sound-damper end pieces may be selected accordingly for the adaptation of such a sound damper. A sound-damper casing selected, or provided, for assignment to a particular application environment may be connected to sound-damper end pieces realized as standard components, and the thus constructed assembly of sound-damper casing and sound-damper end pieces may be integrated into the application environment, thus for example a vehicle, via the fastening elements, which are likewise realized as standard components.

For simple and reliable connection of the sound-damper end pieces to the sound-damper casing and, at the same time, simple integration of the thereby constructed sound damper into an application environment provided for this purpose, it is proposed that at least one sound-damper end piece, preferably each sound-damper end piece, of the first sound-damper end piece and the second sound-damper end piece include an end-piece plate that is connected to the sound-damper casing and an end-piece pipe socket that extends from the end-piece plate in the direction away from the sound-damper casing.

A stable connection of the components of the sound damper, in particular also in consideration of the exhaust gas temperatures generated during operation of a fuel cell, may be achieved, for example, in that at least one sound-damper end piece, preferably each sound-damper end piece, of the first sound-damper end piece and the second sound-damper end piece is connected to the sound-damper casing by material bonding, preferably cementing or welding, for example friction welding or ultrasonic welding.

In another type of attachment of the sound-damper casing to one or both sound-damper end pieces, which may be used as an alternative or in addition to the materially bonded connection, at least one sound-damper end piece, preferably each sound-damper end piece, of the first sound-damper end piece and the second sound-damper end piece may be connected to the sound-damper casing by form closure.

For the simple provision of this form-closure connection, it is proposed that at least one form-closure engagement opening for a form-closure engagement organ be provided on the at least one sound-damper end piece of the first sound-damper end piece and the second sound-damper end piece and/or on the sound-damper casing, and that at least one form-closure engagement organ engage in at least one form-closure engagement opening, preferably each form-closure engagement opening.

For the purpose of producing a latching type form closure, at least one form-closure engagement opening for a form-closure engagement organ may be provided on the sound-damper casing, assigned to the at least one sound-damper end piece of the first sound-damper end piece and the second sound-damper end piece, and at least one form-closure engagement organ may be provided on the at least one sound-damper end piece of the first sound-damper end piece and the second sound-damper end piece, assigned to at least one form-closure engagement opening, preferably each form-closure engagement opening.

To then enable a gas-tight structure to be achieved, a form-closure edge, overlapping the sound-damper casing on an outer side or an inner side in the direction of the sound-damper longitudinal axis, may be provided on the at least one sound-damper end piece of the first sound-damper end piece and the second sound-damper end piece, and the at least one form-closure engagement organ may project, as an integral constituent part of the at least one sound-damper end piece, from the form-closure edge in the direction of the sound-damper casing and engage in the assigned form-closure engagement opening.

For an alternative configuration of the form-closure connection using form-closure engagement organs realized as separate components, it is proposed that at least one form-closure engagement opening for a form-closure engagement organ be provided on the at least one sound-damper end piece of the first sound-damper end piece and the second sound-damper end piece and on the sound-damper casing, and that a form-closure engagement organ be positioned in an engaging manner in at least one pair of form-closure engagement openings positioned to overlap mutually on the sound-damper casing and the at least one sound-damper end piece of the first sound-damper end piece and the second sound-damper end piece.

Also in the case of such a configuration of the form closure, a form-closure edge, overlapping the sound-damper casing on an outer side or an inner side in the direction of the sound-damper longitudinal axis, may be provided on the at least one sound-damper end piece of the first sound-damper end piece and the second sound-damper end piece, and the at least one form-closure engagement opening provided in the at least one sound-damper end piece of the first sound-damper end piece and the second sound-damper end piece may be provided in the form-closure edge.

If the form-closure engagement organs are configured as separate components, at least one form-closure engagement organ, preferably each form-closure engagement organ, may include a threaded bolt or a rivet bolt.

For increased stability and to provide a gas-tight closure, it is proposed that a sealing edge be provided on the at least one sound-damper end piece of the first sound-damper end piece and the second sound-damper end piece, at a radial distance from the form-closure edge, and that an axial end of the sound-damper casing be arranged so as to engage between the form-closure edge and the sealing edge.

To enable the structure to be configured as cost-effectively as possible by the use of identical parts, the first sound-damper end piece and the second sound-damper end piece may be realized such that they are identical to each other.

For a solid connection via the fastening elements, it is proposed that provided on at least one sound-damper end piece, preferably each sound-damper end piece, of the first sound-damper end piece and the second sound-damper end piece there is at least one fastening region, for fastening a fastening element to the at least one sound-damper end piece.

For increased variability and/or stability in integrating a sound damper constructed according to the disclosure into an application environment, two fastening regions may be provided on the at least one sound-damper end piece, each for fastening a fastening element to the at least one sound-damper end piece.

For the purpose of supporting a respective fastening element on a sound-damper end piece, it is proposed that each fastening region provided on the at least one sound-damper end piece have at least one fastening-element contact surface, and that the fastening-element contact surfaces assigned to the two fastening regions be orientated substantially away from each other with respect to the sound-damper longitudinal axis.

Stable attachment of the fastening elements to a respective sound-damper end piece may be ensured, for example, in that each fastening region has at least two fastening points, with a fastening element being able to be fixed to the at least one sound-damper end piece by a fastening organ, preferably a threaded bolt, at each fastening point.

A reliable connection, even under high mechanical load, may then be ensured in that each fastening point includes an internal-thread organ embedded in the plastic material of the at least one sound-damper end piece, preferably with the internal-thread organ being constructed with metal material.

Each fastening region may include at least one fastening projection adjoining the end-piece plate and the end-piece pipe socket of the at least one sound-damper end piece. Thus, the structural strength of a sound-damper end piece in the region of the end-piece plate, or of the end-piece pipe socket, is not impaired by the attaching of one fastening element or a plurality of fastening elements. On the contrary, such a fastening projection enhances the stability of a sound-damper end piece.

If it is then provided that each fastening region include a fastening projection assigned to each fastening point, with the fastening projections assigned to a fastening region, arranged at a distance from one another, the use of excessive quantities of plastic material to construct the sound-damper end pieces is avoided, despite the high structural strength.

For the purpose of attaching to a sound-damper end piece, or a fastening region provided thereon, each fastening element may include a counter-fastening region for fixing to a fastening region.

To improve the sound-damping characteristic, there may be arranged, in the sound-damper casing, sound-damping material that may include, for example, porous or/and foamed material or/and fiber material, or/and cover an inner surface of the sound-damper casing, at least in part.

Since water is produced during the operation of a fuel cell, or is contained in the fuel-cell exhaust, for example in the form of vapor, a liquid collection contour, preferably extending in the direction of the sound-damper longitudinal axis, may be provided on a peripheral region of the sound-damper casing to collect water condensing, or precipitating, in the region of such a sound damper.

For increased stability of the sound damper constructed according to the disclosure, at least one stiffening rib, preferably a plurality of stiffening ribs arranged consecutively in the direction of the sound-damper longitudinal axis, or/and a plurality of stiffening ribs arranged consecutively in the circumferential direction around the sound-damper longitudinal axis, may be provided on an outer side of the sound-damper casing.

Alternatively or additionally, at least one stiffening rib, preferably a plurality of stiffening ribs arranged consecutively in the direction of the sound-damper longitudinal axis, and/or a plurality of stiffening ribs arranged consecutively in the circumferential direction around the sound-damper longitudinal axis, may be provided on an inner side of the sound-damper casing.

The most uniform possible stiffening with ease of production of the sound-damper casing may be achieved if at least one stiffening rib, preferably each stiffening rib, extends substantially in the direction of the sound-damper longitudinal axis, or/and if at least one stiffening rib, preferably each stiffening rib, extends substantially in the circumferential direction around the sound-damper longitudinal axis.

The disclosure also relates to a fuel-cell system, in particular for a vehicle, including at least one fuel cell and a fuel-cell exhaust system receiving fuel-cell exhaust from the at least one fuel cell and having at least one sound damper constructed according to the disclosure.

According to a further aspect, the object stated at the outset is achieved by a method for the production of a sound damper constructed according to the disclosure, including the measures of:
a) providing the sound-damper casing by severing a length section from a sound-damper casing blank,
b) providing the first sound-damper end piece and the second sound-damper end piece,
c) fixing the first sound-damper end piece to the first axial end of the sound-damper casing, and fixing the second sound-damper end piece to the second axial end of the sound-damper casing.

In order to provide the sound-damper casing in a simple and cost-effective manner, the sound-damper casing blank used in the measure a) to provide the sound-damper casing may be produced by extrusion or blow molding.

As the sound-damper end pieces may have a comparatively complex shape compared to the sound-damper casing, it is advantageous if the first sound-damper end piece and the second sound-damper end piece are produced using a plastic casting process.

In order for the sound-damping characteristic to be set in a defined manner, the measure a) may include a measure a1) for arranging sound-damping material in the sound-damper casing.

The sound-damper casing, with sound-damping material integrated into it, may be provided in a simple manner if the measure a1) includes arranging a sound-damping material blank in the sound-damper casing blank before the length section is severed. Alternatively or additionally, the measure a1) may include arranging at least one sound-damping material body in the length section after the length section has been severed.

In order to achieve a stable bond between the sound-damper casing and the sound-damper end pieces, it is proposed that the measure c) includes fixing the first sound-damper end piece and the second sound-damper end piece to the sound-damper casing by material bonding, preferably cementing or welding, and/or by form closure.

In order to configure the sound damper for installation in an application environment, at least one fastening element may additionally be fixed, preferably by screw connection, to at least one sound-damper end piece, preferably each sound-damper end piece, of the first sound-damper end piece and the second sound-damper end piece, in a measure d) preferably performed after the measure c).

### BRIEF DESCRIPTION OF DRAWINGS

The invention will now be described with reference to the drawings wherein:

FIG. 1 shows a side view of a sound damper for an exhaust system of a fuel-cell system;

FIG. 2 shows a perspective view of the sound damper of FIG. 1;

FIG. 3 shows an axial view of the sound damper of FIGS. 1 and 2 in the direction of view III in FIG. 2;

FIG. 4 shows a perspective view of the sound damper of FIGS. 1 and 2 with fastening elements fixed to sound-damper end pieces;

FIG. 5 shows a sound-damper casing of the sound damper of FIGS. 1 and 2 connected to only one sound-damper end piece;

FIG. 6 shows a fastening element for the sound damper of FIGS. 1 and 2;

FIG. 7 shows a representation of an alternative embodiment of a sound-damper casing corresponding to FIG. 5;

FIG. 8 shows a further representation of an alternative embodiment of a sound-damper casing corresponding to FIG. 5;

FIG. 9 shows a further representation of an alternative embodiment of a sound-damper casing corresponding to FIG. 5;

FIG. 10 shows a further representation of an alternative embodiment of a sound-damper casing corresponding to FIG. 5;

FIG. 11 shows an alternative way of attaching a sound-damper end piece to a sound-damper casing;

FIG. 12 shows a detail view of the embodiment represented in FIG. 11;

FIG. 13 shows a further alternative way of attaching a sound-damper end piece to a sound-damper casing; and,

FIG. 14 shows schematic representation of a fuel-cell system.

### DETAILED DESCRIPTION

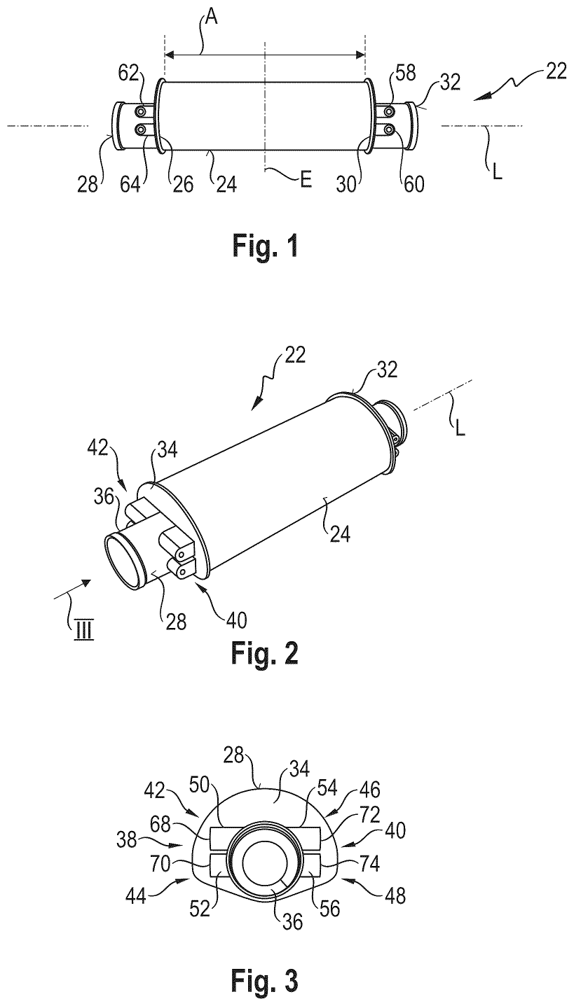

Before the structure of a sound damper is described in detail below with reference to FIGS. 1 to 13, the structure of a fuel cell system 10 in which such a sound damper may be used is explained with reference to FIG. 14.

The fuel-cell system 10 includes a fuel cell 12 in particular a PEM fuel cell realized, for example, as a fuel-cell stack, having an anode region 14 and a cathode region 18 separated from the anode region 14 by a polymer membrane 16. Hydrogen H2 or a gas containing hydrogen is supplied to the anode region 14 as anode gas. Oxygen, or a gas containing oxygen, for example air L, is supplied to the cathode region 18 as cathode gas. Cathode exhaust gas and/or anode exhaust gas produced during fuel cell operation is supplied to an exhaust system 20 of the fuel cell system 10 as fuel-cell exhaust and is emitted to the environment via the exhaust system 20.

The exhaust system 20 may include various system regions. In particular, the exhaust system 20 may include a sound damper 22 carried on a support structure T, for example the underbody of a vehicle, which serves to damp noise produced during operation of the fuel-cell system 10, such that this noise is not emitted, or is only emitted having been damped, to the environment via the fuel-cell exhaust. Further system regions such as, for example, a separate water separator for separating water, or vapor, contained in the fuel-cell exhaust, may also be provided in the exhaust system 20.

The structure of the sound damper 22, or the procedure for the production of the sound damper 22 of the exhaust system 20, is explained below with reference to FIGS. 1 to 13 in conjunction with various embodiments of such a sound damper 22.

The sound damper 22 is basically elongate in the direction of a sound-damper longitudinal axis L, and has a tubular sound-damper casing 24 that is elongate in the direction of the sound-damper longitudinal axis L. Since the temperature of the fuel-cell exhaust generally does not exceed a value of 120° C., the fuel cell casing 24 is made of plastic material for reasons of cost and weight.

Fixed to a first axial end 26 of the fuel cell casing 24 there is a first sound-damper end piece 28. The first sound-damper end piece 28 is likewise constructed with plastic material and may be connected to the sound-damper casing 24 in a fixed and gas-tight manner by material bonding, for example by cementing or welding, in particular friction welding or ultrasonic welding.

Fixed to a second axial end 30 of the sound-damper casing 24 there is a second sound-damper end piece 32. The second sound-damper end piece 32, which is of the same configuration as the first sound-damper end piece 28, that is, of identical construction to the latter, is similarly connected to the sound-damper casing 24 by material bonding. Since the two sound-damper end pieces 28, 32 are identical to each other in their construction, and preferably the sound-damper casing 24 has a cylindrical shape in the direction of the sound-damper longitudinal axis L, that is, a shape that does not change its cross-section, the entire sound damper 22 is constructed substantially mirror symmetrically with respect to a sound-damper center plane E orthogonal to the sound-damper longitudinal axis L.

As can be seen in FIGS. 2 and 3 from the first sound-damper end piece 28 fixed to the first end 26 of the sound-damper casing 24, each of the two sound-damper end pieces 28, 32, which are identical to each other in their construction, has an end-piece plate 34 connected to the sound-damper casing 24, and an end-piece pipe socket 36 extending from the end-piece plate 34 in the direction away from the sound-damper casing 24. Further tubular, or hose-like, exhaust system components of the exhaust system 20 may be coupled to the end-piece pipe socket 36.

Each of the two sound-damper end pieces 28, 30 has two fastening regions 38, 40. A fastening element 41, represented in FIG. 6, may be fixed in each fastening region 38, 40. Via such fastening elements 41, the sound damper 22 may be fixed to the support structure T.

Each fastening region 38, 40 includes two fastening points 42, 44 and 46, 48, respectively. Each fastening point 42, 44, 46, 48 includes a fastening projection 50, 52, 54, 56, which is realized as an integral component part of the respective sound-damper end piece 28, 32, and which extends in the adjoining region of the end-piece pipe socket 36 to the end-piece plate 34, or adjoins it, respectively. It can be seen in FIG. 3 that there is an interspace between the two fastening projections 50, 52 and 54, 56 assigned to a respective fastening region 38, 40, such that an excessive use of plastic material for the construction of the sound-damper end pieces 28, 32 can be avoided while maintaining high structural strength.

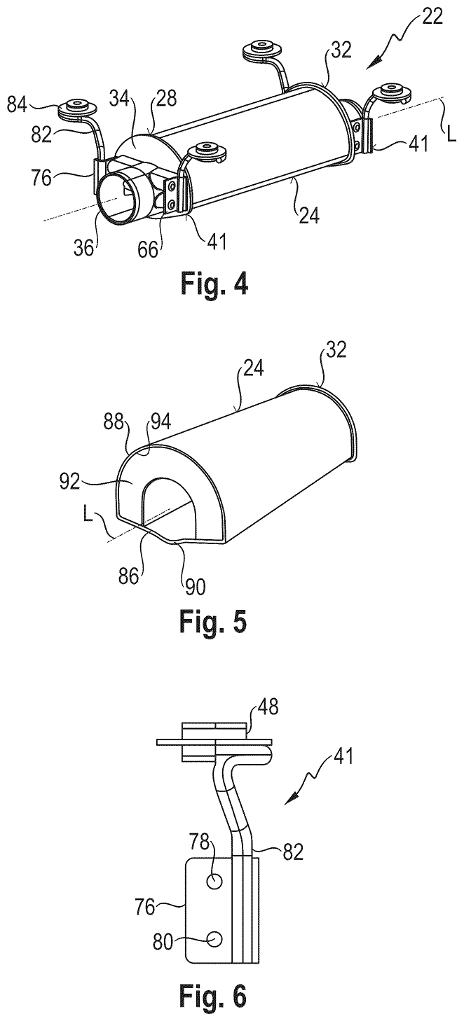

In each of the fastening projections 50, 52, 54, 56, there is an internal-thread organ 58, 60, 62, 64, realized in the manner of a nut, in order to provide a respective fastening point 42, 44 or 46, 48. The internal-thread organs 58, 60, 62, 64 may, for example, be encapsulated by the plastic construction material for the sound-damper end pieces 28, 32 during the production of the sound-damper end pieces 28, 30 in a plastic casting process. Alternatively, the internal-thread organs 58, 60, 62, 64 may be retrofitted into the sound-damper end pieces 28, 32 and fixed therein, for example by cementing. In a further alternative embodiment, the fastening points 42, 44, 46, 48 may include openings that are provided in the respective fastening projections 50, 52, 54, 56, and that may be realized, for example, with an internal thread, or into which fastening organs 66, for example threaded bolts, inserted to secure the fastening elements 41 and visible in FIG. 4, may be threadably engaged.

Each of the fastening regions 38, 40 provides, respectively, on the two fastening projections 50, 52 and 54, 56 of the same, fastening-element contact surfaces 68, 70 and 72, 74, on which a respective plate-like counter-fastening region 76 of the fastening elements 41 may be brought into surface contact. Provided in the counter-fastening region 76 there are through-openings 78, 80, through which the fastening organs 66, used to fix a respective fastening element 41 to one of the fastening regions 38, 40, may be inserted into the fastening projections 50, 52, 54, 56.

For the purpose of attaching to the support structure T, the fastening elements 41, which may preferably likewise be of the same configuration as each other, that is, identical to one another in their construction, have, extending from the counter-fastening region 76, a leg 82, provided at the end of which, remote from the counter-fastening region 76, is a connection element 48, for example constructed with elastic material. A further fastening organ, realized for example as a threaded bolt or the like, may be inserted through this into the support structure T, in order thereby to ensure that a respective fastening element 41 is fixedly attached to the support structure T.

As can be seen clearly in FIG. 5, the sound-damper casing 24, which is realized in the direction of the sound-damper longitudinal axis L with a preferably cylindrical shape, has a bottom region 86 in a circumferential region thereof, adjoining which is a curved region 88 providing the further circumferential region of the sound-damper casing 24. The bottom region 86 may have a slope on both sides in the direction of a liquid collection contour 90, such that liquid settling in the inner region of the sound damper 22 collects in the bottom region 86 positioned at the bottom in the vertical direction, or in the liquid collection contour 90. With the exception of the openings realized in the end-piece pipe sockets 36 of the sound-damper end pieces 28, 32 for the intake and discharge of fuel cell exhaust, the sound damper 22 has no further openings in the sound-damper casing 24, or the sound-damper end pieces 28, 32. Liquid that accumulates in the region of the liquid collection contour 90 in the sound damper 22 during fuel cell operation is discharged from the sound damper 22 by the comparatively warm fuel-cell exhaust flowing through the latter.

FIG. 5 also shows that there is sound-damping material 92 arranged inside the sound damper 22. The sound-damping material 92 may, for example, cover the sound-damper casing 24 on its inner surface 94 in the arcuate region 88. The sound-damping material 24 may be constructed with porous material, for example an open-cell foam material or the like, and thus, by absorption, contribute efficiently to damping noise propagating in the fuel-cell exhaust. In an alternative embodiment, the sound-damping material 92 may be constructed with fiber material, for example a PET fleece or the like.

In the production of the sound damper 22, the two sound-damper end pieces 28, 32, having the mutually identical construction described above, may be produced as standard components in a plastic casting process, for example injection molding or the like. This makes it possible to provide the sound-damper end pieces 28, 32 in a simple and precise manner with comparatively complex shaping.

The sound-damper casing 24 may be provided by severing a length section A from a sound-damper casing blank. The sound-damper casing blank may be produced, for example, in an extrusion process or a blow molding process with substantially any cross-sectional geometry and length. The sound-damper casing 24, having the length of the length section A suitable for a particular application and the sound damping characteristic to be achieved for it, may be severed from such a sound-damper casing blank and made available for the further production of the sound damper 22.

On the sound-damper casing 24 provided in this way, the two sound-damper end pieces 28, 32 may be attached to the two axial ends 26, 30 by material bonding. Preferably after the sound-damper end pieces 28, 32 have been attached to the sound-damper casing 24, the fastening elements 41 are attached to the two sound-damper end pieces 28, 30 at one or both fastening regions 38, 40.

The sound-damping material 92 may be provided inside the sound-damper casing 24, for example, by the inclusion of a sound-damping material blank in the sound-damper casing blank during the production process. For example, during the process of producing the sound-damper casing blank, a sound-damping material blank may be formed with the construction material of the sound-damper casing 23, or a sound-damping material blank may be pressed into the sound-damper casing blank. Then, when the length section A is severed from the sound-damper casing blank, a corresponding length section of the sound-damping material is separated from the sound-damping material blank.

Alternatively, after the length section A has been separated of from the sound-damper casing blank, a sound-damping material body may be inserted, or pressed, into the length section A. This sound-damping material body may be provided, for example, by severing it from a sound-damping material blank. A plurality of such sound-damping material bodies may also be arranged in the sound-damper casing 24, and it is possible for the two alternatives, described above, for providing the sound-damping material 92 in the sound-damper casing 24 to be combined with each other.

The sound-damping material 92 is held axially in the sound-damper casing 24 by the two sound-damper end pieces 28, 32 attached to its axial ends 26, 30, such that no additional fastening measures are required.

With the sound damper constructed according to the disclosure, or the method for its production, it is possible in a simple manner to achieve adaptation of the sound damper to different application environments by using standard components in that, adapted to a respective application environment, the sound-damper casing is provided with the length intended for the sound damping characteristic to be achieved, and the sound-damper end pieces, constructed as identical parts, are attached to the two axial ends of the casing. Standard production processes and, in particular, standard materials may be used for the production of all components of the sound damper, which on the one hand results in simple and reliable production processes, and on the other hand results in a sound damper structure that is suitable for the intended application without substantial further adaptation measures.

Since the sound-damper end pieces attached to the axial ends of the sound-damper casing are used for attaching the fastening elements intended for fixing the sound damper to a support structure, it is not necessary to provide any structural measures on the sound-damper casing itself for attaching such fastening elements to it. This helps to make the sound-damper casing easy to produce by the severing of a length section from a prefabricated sound-damper casing blank.

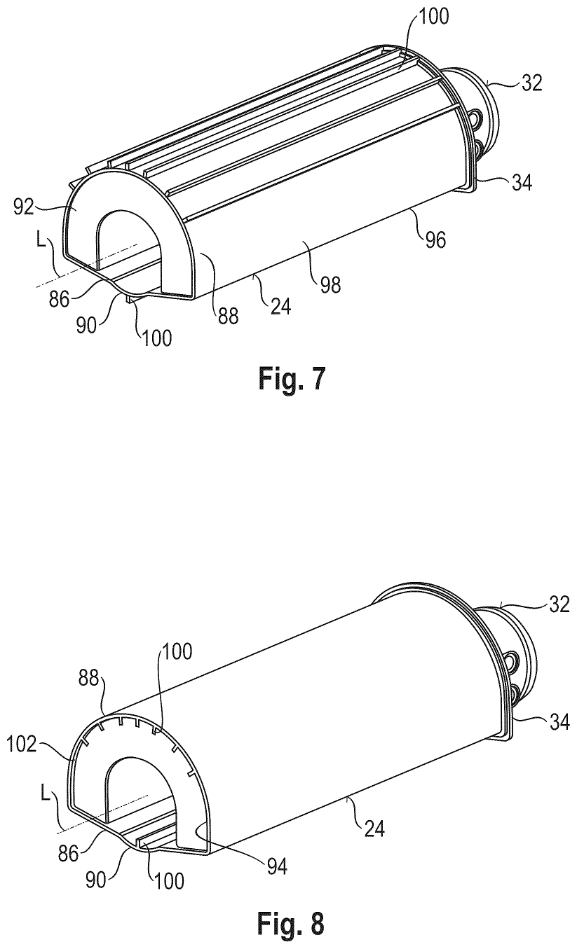

FIG. 7 shows a representation of an alternative embodiment of the sound-

damper casing 24 corresponding to FIG. 5. A plurality of stiffening ribs 100, extending substantially in the direction of the sound-damper longitudinal axis L, are provided on an outer side 96 of the sound-damper casing 24, projecting outward from an outer surface 98. The stiffening ribs 100 provided in the arcuate region 88 have a substantially uniform spacing from one another in the circumferential direction around the sound-damper longitudinal axis L. Such a stiffening rib 100 may also be provided in the bottom region 86, for example in the region of the collection contour 90, extending in the direction of the sound-damper longitudinal axis L. A plurality of stiffening ribs 100 may also be provided, for example, on the bottom region 86, extending laterally next to one another substantially in the direction of the sound-damper longitudinal axis L.

In the case of an alternative embodiment represented in FIG. 8, the stiffening ribs 100 on the arcuate portion 88 and the stiffening rib 100 on the bottom portion 86 are realized such that they project inwardly from the inner surface 94, on an inner side 102 of the sound-damper casing 24. These stiffening ribs 100 also extend substantially in the direction of the sound-damper longitudinal axis L. The stiffening ribs 100 provided on the arcuate portion 88 engage in the sound-damping material 92 and thus contribute to an additional form-closure locking of the same.

Since, in the case of the embodiments of the sound-damper casing 24 represented in FIGS. 7 and 8, the stiffening ribs 100 extend substantially in the direction of the sound-damper longitudinal axis L, which also corresponds substantially to the direction of production in the production of a sound-damper casing blank in an extrusion process, these stiffening ribs 100 may be formed concomitantly in the process of extruding the sound-damper casing blank.

Since end faces are also formed in the region of the stiffening ribs 24 when a length section is severed from the sound-damper casing blank to provide a sound-damper casing 24, a larger overall surface area is available for attaching the sound-damper end pieces 28, 32 by material bonding to the sound-damper casing 24. For this purpose it is advantageous, particularly when the stiffening ribs 100 are provided on the outer side 96 of the sound-damper casing 24, if, as can also be seen in particular in FIG. 7, the end-piece plates 34 of the sound-damper end pieces 28, 32 project radially outward beyond the outer side 96 of the sound-damper casing 24, preferably to such an extent that radially outward they end flush with the stiffening ribs 100.

It should be emphasized that such stiffening ribs 100, extending substantially in the direction of the sound-damper longitudinal axis L, may be provided on the sound-damper casing 24 both on the outer side 96 and on the inner side 102.

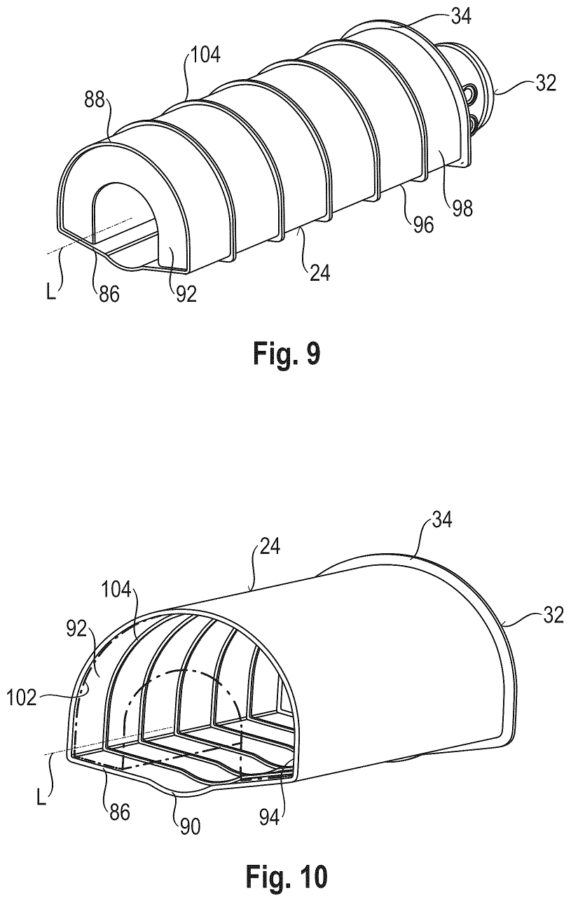

An alternative configuration of the sound-damper casing 24 is represented in FIG. 9. In the case of this embodiment, stiffening ribs 104 are provided on the outer side 96, projecting radially outward from the outer surface 98 with respect to the sound-damper longitudinal axis L and extending substantially in the circumferential direction around the sound-damper longitudinal axis L. The stiffening ribs 104 arranged consecutively in the direction of the sound-damper longitudinal axis L preferably have a uniform spacing from one another.

In a modification of this embodiment shown in FIG. 10, such stiffening ribs 104, extending in the circumferential direction around the sound-damper longitudinal axis L, are arranged on the inner side 102 so as to project radially inward with respect to the inner surface 94. To make these visible, the sound-damping material 92 is shown in a transparent representation in FIG. 10.

The stiffening ribs 104 extending in the circumferential direction around the sound-damper longitudinal axis L preferably run uninterruptedly along the outer side 96, or the inner side 102, of the sound-damper casing 24. With this configuration also, it is possible to provide such stiffening ribs 104, extending in the circumferential direction around the sound-damper longitudinal axis L, both on the outer side 96 and on the inner side 102.

For the production of a sound-damper casing 24 including the stiffening ribs 104, or a sound-damper casing blank therefor, a blow molding process is preferably used, enabling the sound-damper casing blank to be produced even with a contour that changes in its longitudinal direction.

With reference to the embodiments of the sound-damper casing 24 represented in FIGS. 7 to 10, it should be further pointed out that these four different embodiments may be combined with each other in any way. Stiffening ribs 100, 104 of any type may be provided both on the outer side 96 and on the inner side 102, such that, for example, there is also a lattice-like pattern of stiffening ribs 100, 104 on the outer side 96 or/and on the inner side 102. The stiffening ribs 100, or 104, may also have an orientation that deviates from an exact orientation in the direction of the sound-damper longitudinal axis L or in the circumferential direction around it, such that, for example, the stiffening ribs 100 form a helical stiffening pattern. In this case, also, a blow molding process is particularly suitable for the production of such a sound-damper casing 24, or a sound-damper casing blank.

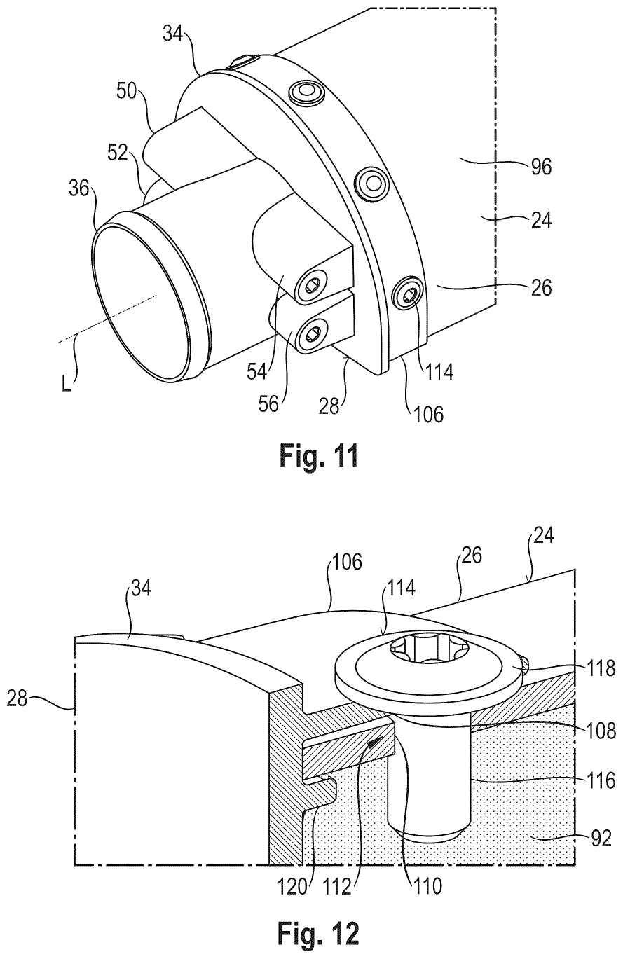

FIGS. 11 and 12, using the sound-damper end piece 28, show an example of an alternative way of attaching the sound-damper end pieces 28, 32 to the sound-damper casing 24. In the case of the sound-damper end piece 28 that can be seen in FIG. 11, a form-closure edge 106 is realized as an integral constituent part of the sound-damper end piece 28, projecting from the end-piece plate 34 of the same in the direction of the sound-damper longitudinal axis L. The form-closure edge 106 overlaps the sound-damper casing 24 at its outer side 96. The form-closure edge 106 overlaps the sound-damper casing 24 on the outer side 96 thereof.

In the form-closure edge 106 and the sound-damper casing 24, respective form-closure engagement openings 108, 110 are provided in the circumferential direction, preferably succeeding one another with uniform spacing, such that, with the form-closure edge 106 axially overlapping the sound-damper casing 24, respective pairs 112 of form-closure engagement openings 108 are formed in the form-closure edge 106, and form-closure engagement openings 110 are formed in the sound-damper casing 24.

The form closure acting in the direction of the sound-damper longitudinal axis L is produced by form-closure engagement organs 114 that, in the embodiment example represented, are realized as threaded bolts. These are guided from radially outside through the overlapping form-closure engagement openings 108, 110, positioned in a mutually overlapping manner, of the pairs 112. The form-closure engagement organs 114, realized as threaded bolts, may have, for example on a shaft 116 thereof, a self-cutting thread that cuts into the plastic construction material of the form-closure edge 106 and/or into the plastic construction material of the sound-damper casing 24, and possibly also into the sound-damping material 92, thus creating a stable locking of the form-closure engagement organs 114. A head 118 of the form-closure engagement organs 114 covers the respectively penetrated form-closure engagement opening 108 in the form-closure edge 106 and creates a substantially gas-tight closure at this site.

In order in principle to achieve gas-tight attachment of the sound-damper end pieces 28, 32 to the sound-damper casing 24 by form closure, the form-closure edge 106 may be realized in accordance with the dimensions of the sound-damper casing 24 in such a way that the sound-damper casing 24 is received with its respective axial end 26, 30 with a tight fit in the associated form-closure edge. In addition, a sealing edge 120, projecting in the direction of the sound-damper longitudinal axis L, may be realized radially inside the form-closure edge 106 on the end-piece plate 34, the radial distance of which from the form-closure edge 106 is such that the axial end 26 of the sound-damper casing 24 is received with a tight fit between the sealing edge 120 and the form-closure edge 106, thus forming a labyrinth seal.

As an alternative to the use of threaded bolts as form-closure engagement organs, it is also possible to use rivet bolts that are deformed through the form-closure engagement openings 108, 110 of a respective pair 112 and thus on the one hand produce a stable cohesion, and on the other hand produce a gas-tight closure via a respective rivet head.

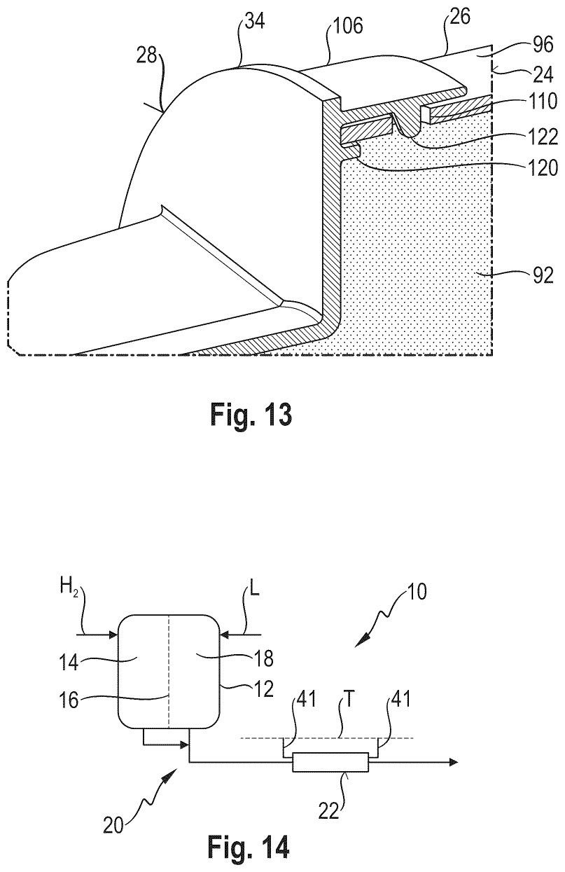

An alternative configuration of such a form-closure connection is represented in FIG. 13, using the example of the sound-damper end piece 28. In the sound-damper casing 24, a plurality of form-closure engagement openings 110 are realized in the circumferential direction around the sound-damper longitudinal axis L, assigned the sound-damper end piece 28. Assigned to at least some of the form-closure engagement openings 110 on the sound-damper casing 24, preferably to each form-closure engagement opening 110, a form-closure engagement organ 122, in the form of an engagement projection, is realized on the form-closure edge 106 as an integral constituent part of the form-closure edge 106, and thus of the sound-damper end piece 28.

To produce the form closure, the sound-damper end piece 28 is pushed axially onto the sound-damper casing 24. As the latter is constructed with plastic material that is basically deformable, the sound-damper casing 24 is first compressed radially inward until the form-closure engagement organs 122 engage from radially outward in the assigned form-closure engagement openings 110. It may also be provided in this case, for example, that the form-closure edge 106 is realized in an interrupted manner in the circumferential direction and has a plurality of tongue-like edge portions, and a form-closure engagement organ 122 may be provided, for example, on each edge portion. When pushed onto the sound-damper casing 24, these edge sections of the form-closure edge 106 may be deformed radially outward and spring back radially inward when the form-closure engagement projections 122 latch into the assigned form-closure engagement openings 110.

In the case of this embodiment, a gas-tight closure may also be achieved, or assisted, in that the sealing edge 120 is provided radially inside the form-closure edge 106, preferably engaging axially over the sound-damper casing 24 on its inner side 102 in such a way that the sealing edge 102 lies against the inner surface 94 and thereby creates a tight closure, for example in the manner of a labyrinth seal.

In the case of the embodiments represented in FIGS. 11 to 13, the form-closure edge 106 on the respective sound-damper end piece 28, 32 may in principle also be realized in such a way that it is positioned to engage in the respective axial end 26, 30 of the sound-damper casing 24 upon being joined together axially, and thus engages axially over the sound-damper casing 24 on its inner side 102. The form-closure engagement organs 114 of the embodiment shown in FIGS. 11 and 12, realized as separate components, are then passed from radially outside first through the form-closure engagement openings 110 of the sound-damper casing 24 and then through the form-closure engagement openings 108 in the form-closure edge 106. The form-closure engagement organs 122, realized as an integral constituent part of the form-closure edge 106 of the embodiment of FIG. 13, project radially outward from the form-closure edge 106 and, upon being joined together, engage from radially inside into the assigned form-closure engagement openings 110 of the sound-damper casing.

It is understood that the foregoing description is that of the preferred embodiments of the invention and that various changes and modifications may be made thereto without departing from the spirit and scope of the invention as defined in the appended claims.

1. A sound damper comprising:
a tubular sound-damper casing defining a longitudinal axis and having first and second axial ends;
said tubular sound-damper casing being made of plastic material and being elongated in along said longitudinal axis;
a first sound-damper end piece made of plastic material and being fixed to said sound-damper casing at said first axial end thereof;
a second sound-damper end piece made of plastic material and being fixed to said sound-damper casing at said second axial end thereof; and,
at least one fastening element for fastening said sound damper to a support structure and said at least one fastening element being on at least one of said sound-damper end pieces.

2. The sound damper of claim 1, wherein at least one of the following applies:
i) at least one of said first and second sound-damper end piece includes an end-piece plate connected to said sound-damper casing and an end-piece pipe socket extending from said end-piece plate in a direction away from said sound-damper casing; and,
ii) said first and second sound-damper end pieces include respective first and second end-piece plates connected to said sound-damper casing and include respective end-piece pipe sockets extending from respective ones of said end-piece plates in a direction away from said sound-damper casing.

3. The sound damper of claim 1, wherein at least one of the following applies:
i) at least one sound-damper end piece of said first and second sound-damper end pieces is connected to said sound-damper casing by material bonding including cementing and welding; and,
ii) said first and second sound-damper end pieces are connected to said sound-damper casing by material bonding including cementing and welding.

4. The sound damper of claim 1, wherein at least one of the following applies:
i) at least one of said first and second sound-damper end pieces is connected to said sound-damper casing by form closure; and,
ii) said first and second sound-damper end pieces are connected to said sound-damper casing by form closure.

5. The sound damper of claim 4, wherein at least one form-closure engagement opening for a form-closure engagement organ is provided on at least one of:
i) said at least one sound-damper end piece of said first sound-damper end piece and said second sound-damper end piece; and,
ii) on said sound-damper casing; and,
at least one form-closure engagement organ engages in said at least one form-closure engagement opening.

6. The sound damper of claim 5, wherein said at least one form-closure engagement opening for said form-closure engagement organ is provided on said sound-damper casing, assigned to said at least one sound-damper end piece of said first sound-damper end piece and said second sound-damper end piece; and, said at least one form-closure engagement organ is provided on said at least one sound-damper end piece of said first sound-damper end piece and said second sound-damper end piece, assigned to at least one form-closure engagement opening.

7. The sound damper of claim 6, wherein a form-closure edge, overlapping said sound-damper casing on an outer side or an inner side in the direction of the sound-damper longitudinal axis, is provided on said at least one sound-damper end piece of said first sound-damper end piece and said second sound-damper end piece, and said at least one form-closure engagement organ projects from said form-closure edge in the direction of the sound-damper casing and engages in the assigned form-closure engagement opening.

8. The sound damper of claim 5, wherein at least one form-closure engagement opening for a form-closure engagement organ is provided on said at least one sound-damper end piece of said first sound-damper end piece and said second sound-damper end piece and on the sound-damper casing, and a form-closure engagement organ is positioned in an engaging manner in at least one pair of form-closure engagement openings positioned to overlap mutually on said sound-damper casing and said at least one sound-damper end piece of said first sound-damper end piece and said second sound-damper end piece.

9. The sound damper of claim 8, wherein a form-closure edge, overlapping said sound-damper casing on an outer side or an inner side in the direction of the sound-damper longitudinal axis, is provided on said at least one sound-damper end piece of said first sound-damper end piece and said second sound-damper end piece, and the at least one form-closure engagement opening provided in the at least one sound-damper end piece of said first sound-damper end piece and said second sound-damper end piece is provided in the form-closure edge.

10. The sound damper of claim 8, wherein at least one form-closure engagement organ comprises a threaded bolt or a rivet bolt.

11. The sound damper of claim 7, wherein a sealing edge is provided on said at least one sound-damper end piece of said first sound-damper end piece and said second sound-damper end piece, at a radial distance from the form-closure edge, and an axial end of the sound-damper casing is arranged so as to engage between the form-closure edge and the sealing edge.

12. The sound damper of claim 7, wherein said first sound-damper end piece and said second sound-damper end piece are realized such that they are identical to each other.

13. The sound damper of claim 2, wherein provided on at least one sound-damper end piece, of said first sound-damper end piece and said second sound-damper end piece there is at least one fastening region, for fastening a fastening element to the at least one sound-damper end piece).

14. The sound damper of claim 13, wherein two fastening regions are provided on said at least one sound-damper end piece, each for fastening a fastening element to said at least one sound-damper end piece.

15. The sound damper of claim 14, wherein each fastening region provided on said at least one sound-damper end piece has at least one fastening-element contact surface, and said fastening-element contact surfaces assigned to said two fastening regions are orientated substantially away from each other with respect to the sound-damper longitudinal axis.

16. The sound damper of claim 13, wherein each fastening region has at least two fastening points, with a fastening element being fixable to the at least one sound-damper end piece by a fastening organ including a threaded bolt, at each fastening point.

17. The sound damper of claim 16, wherein each fastening point comprises an internal-thread organ embedded in the plastic material of said at least one sound-damper end piece.

18. The sound damper of claim 17, wherein each fastening region comprises at least one fastening projection adjoining said end-piece plate and said end-piece pipe socket of said at least one sound-damper end piece.

19. The sound damper of claim 18, wherein each fastening region comprises a fastening projection assigned to each fastening point, with the fastening projections assigned to a fastening region, arranged at a distance from one another.

20. The sound damper of claim 13, wherein each fastening element comprises a counter-fastening region for fixing to a fastening region.

21. The sound damper of claim 1, wherein sound-damping material is arranged in the sound-damper casing, the sound-damping material comprising at least one of: i) porous material; ii) foamed material; and, iii) fiber material; and,
the sound-damping material covers an inner surface of said sound-damper casing at least in part.

22. The sound damper of claim 1, wherein a liquid collection contour is provided on a peripheral region of said sound-damper casing.

23. The sound damper of claim 1, wherein at least one of the following applies: i) at least one stiffening rib in the direction of the sound-damper longitudinal axis; and, ii) a plurality of stiffening ribs arranged consecutively in the circumferential direction around the sound-damper longitudinal axis is provided on an outer side of the sound-damper casing.

24. The sound damper of claim 1, wherein at least one of the following is provided on an inner side of the sound-damper casing: i) at least one stiffening rib arranged in the direction of the sound-damper longitudinal axis; and, ii) a plurality of stiffening ribs arranged consecutively in the circumferential direction around the sound-damper longitudinal axis.

25. The sound damper of claim 23, wherein at least one of the following applies: i) at least one stiffening rib extends in the direction of the sound-damper longitudinal axis; and, ii) at least one stiffening rib extends in the circumferential direction around the sound-damper longitudinal axis.

26. A fuel-cell system comprising:
at least one fuel cell;
a fuel-cell exhaust system receiving fuel-cell exhaust from the at least one fuel cell; and,
a sound damper including:
a tubular sound-damper casing defining a longitudinal axis and having first and second axial ends;
said tubular sound-damper casing being made of plastic material and being elongated in along said longitudinal axis;
a first sound-damper end piece made of plastic material and being fixed to said sound-damper casing at said first axial end thereof;
a second sound-damper end piece made of plastic material and being fixed to said sound-damper casing at said second axial end thereof; and, at least one fastening element for fastening said sound damper to a support structure and said at least one fastening element being on at least one of said sound-damper end pieces.

27. A method for making a sound damper including: a tubular sound-damper casing defining a longitudinal axis and having first and second axial ends; said tubular sound-damper casing being made of plastic material and being elongated in along said longitudinal axis; a first sound-damper end piece made of plastic material and being fixed to said sound-damper casing at said first axial end thereof; a second sound-damper end piece made of plastic material and being fixed to said sound-damper casing at said second axial end thereof; and, at least one fastening element for fastening said sound damper to a support structure and said at least one fastening element being on at least one of said sound-damper end pieces, the method comprising the steps of:
a) severing a length section from a sound-damper casing blank to provide the sound-damper casing;
b) providing the first sound-damper end piece and the second sound-damper end piece; and,
c) fixing the first sound-damper end piece to the first axial end of the sound-damper casing and fixing the second sound-damper end piece to the second axial end of the sound-damper casing.

28. The method of claim 27, wherein the sound-damper casing blank used in the step a) to provide the sound-damper casing is made by extrusion or blow molding.

29. The method of claim 27, wherein the first sound-damper end piece and the second sound-damper end piece are made using a plastic casting process.

30. The method of claim 27, wherein the step a) includes a step a1) for arranging sound-damping material in the sound-damper casing.

31. The method of claim 30, wherein at least one of the following applies:
i) the step a1) comprises arranging a sound-damping material blank in the sound-damper casing blank before the length section is severed; and,
ii) the measure a1) comprises arranging at least one sound-damping material body in the length section after the length section has been severed.

32. The method of claim 27, wherein the step c) comprises fixing the first sound-damper end piece and the second sound-damper end piece to the sound-damper casing by material bonding via cementing or welding and/or by form closure.

33. The method of claim 27, wherein at least one fastening element is fixed to at least one sound-damper end piece of the first sound-damper end piece and the second sound-damper end piece in a step d).

34. The method of claim 33, wherein the at least one fastening element is fixed by threadable engagement.

35. The sound damper of claim 17, wherein the internal thread organ is made with metal material.

36. The sound damper of claim 22, wherein said liquid collection contour extends in the direction of the sound damper longitudinal axis.

37. The sound damper of claim 1, wherein said sound damper is for a vehicle.
